(19) United States
(12) Patent Application Publication
(10) Pub. No.: US 2001/0048866 A1
(43) Pub. Date: Dec. 6, 2001

(54) CONTAINER AND LOADER FOR SUBSTRATE

(76) Inventors: FUMIO SAKIYA, FUKAYASU-GUN, HIROSHIMA-KEN (JP); MINEO KINPARA, FUKAYASU-GUN, HIROSHIMA-KEN (JP); KOJI OHYAMA, MINATO-KU, TOKYO (JP); TOSHIYA NAKAYAMA, MINATO-KU, TOKYO (JP); TOSHIAKI FUJII, FUJISAWA-SHI, KANAGAWA-KEN (JP); OSAMU HORITA, FUJISAWA-SHI, KANAGAWA-KEN (JP)

Correspondence Address: CANTOR COLBURN, LLP, 55 GRIFFIN ROAD SOUTH, BLOOMFIELD, CT, 06002

(21) Appl. No.: 09/180,848

(22) PCT Filed: Dec. 1, 1997
(86) PCT No.: PCT/JP97/04372

§ 371 Date: None

(51) Int. Cl. B65G 49/07

(52) U.S. Cl. 414/217; 414/411; 414/937

(57) ABSTRACT

A loader disposed in a low cleanliness room along a border between the low cleanliness room and a high cleanliness room, for transporting a dust free article between an inside of a container receiving the dust free article to the high cleanliness room, which comprises: (a) a stage for mounting the container; (b) an opening portion through which the dust free article is transported between the inside of the container and the high cleanliness room; (c) a door for opening and closing the opening portion; (d) unifying means for unifying a cover of the container and the door when the container approaches the door; and (e) a driving means for transferring unified cover and door within the loader to simultaneously open and close the opening portion and the container.

### BACKGROUND OF THE INVENTION

1. Field of the Invention

The present invention relates to a container and a loader for an article such as a substrate necessary to be kept under the condition of high cleanliness during being transported and worked, in particular the present invention relates to transporting means (hereinafter referred to as “loader” ) to transport the substrate or the like between the container used for transporting the substrate or the like through a low cleanliness room and a high cleanliness room for working the substrate or the like.

The present invention is applicable to any article necessary to be kept under the condition of high cleanliness during being transported and worked. It is described hereunder in relation to a semiconductor substrate such as a silicon wafer or a liquid crystal substrate, in particular a semiconductor wafer as an example, however, the present invention is not limited to the above.

2. Background of the Invention

The semiconductor substrate, in particular semiconductor wafer is contaminated when dust or vaporized organic compounds (hereinafter referred to as “dust”) are attached thereto, thus leading to a lower productivity, i.e., the rate of producing a high-quality of product is low. It is therefore necessary to maintain high cleanliness in the surroundings of the substrate or the like when the semiconductor wafer is transported or worked. More specifically, the semiconductor wafer is one of the articles necessary to be kept under the condition of high cleanliness during transported and worked (hereinafter referred to as “dust free article”).

In general, the semiconductor wafer is worked in a room where cleanliness is high (hereinafter referred to as a “high cleanliness room”), i.e., so called a clean room. On the other hand, when the semiconductor wafer is transported, the semiconductor wafer is received in an air-tightly sealed container, the inside of which is kept under the condition of high cleanliness (hereinafter referred to as a “container”), and then, the container with the semiconductor wafer received therein is transported. Thus, the semiconductor wafer can be transported through a room in which the degree of cleanliness is low or outdoor (hereinafter referred to as “low cleanliness room”), avoiding the semiconductor wafer from being contaminated during transported.

There is disposed a loader with an opening portion, which can be closed, in the border portion between the high cleanliness room and the low cleanliness room. The semiconductor wafer is transported through the above loader from the inner space of the container with high cleanliness for working the semiconductor wafer to the high cleanliness room (hereinafter referred to as “loading”), in addition, from the high cleanliness room to the inner space of the container with high cleanliness for transferring to an another treatment step (hereinafter referred to as “unloading”). More specifically, the semiconductor wafer is moved through the above opening portion. The container has a cover (i.e., lid) in a direction to the opening portion of the loader, which cover is opened when the semiconductor wafer is transferred.

When the semiconductor wafer is not transported, the opening portion of the loader is kept closed so as to prevent dust from floating into the high cleanliness room from the low cleanliness room. A door may be disposed in the opening portion so that the opening portion can be opened or closed by the door.

In this case, the door may be large enough to completely close the opening portion. In addition, the door may be the size in which the door is about 5 mm smaller in each side than respective side of the opening portion in such manner that there is provided aperture (open space) between the door and the opening portion, while the air pressure in the high cleanliness room is kept higher than that in the lower cleanliness room, thus air flows through the aperture from the high cleanliness room to the low cleanliness room.

The following standards for the above container and loader are proposed and applied: SEMI (Semiconductor Equipment and Material International) Standard E47.1 [Box/Pod (FOUP)], E15.1[Tool Load Port], E57[Kinematic Coupling], E62[FrontOpening Interface Standard (FIMS), E63 [Box/Opener to Tool Standard (BOLTS) and the like (hereinafter referred to as “Standard”).

### PRIOR ART

The semiconductor wafer is transported through the opening portion between the container with the door opened and the high cleanliness room. However, as described above, it is essential to consider that the semiconductor wafer is not contaminated by dust. It is therefore necessary to note that the dust floating in the low cleanliness room, the dust attached to the container, particularly, the cover of the container, the dust attached to the door of the loader in the side of the lower cleanliness room or the dust generated along with the driving of the loader has to be prevented from floating into the high cleanliness room.

As one of the methods to realize the above requirement to prevent the dust from floating into the high cleanliness room, there is disclosed the method in German Patent Application No. 19511024-2 (filed on Mar. 28, 1995), German Patent Application No. 19542646-2 (filed on Nov. 15, 1995), and Japanese Patent Provisional Publication No. 8-279546. The method is described hereinbelow with reference to FIG. 1.

A wall 105 separates a high cleanliness room in the right hand side in the drawing from a low cleanliness room in the left hand side in the drawing. An opening portion of the wall 105 is closed by the door 104 of a loader. A semiconductor wafer 101 is received inside of a container 102, and dust is prevented from floating into the container by a cover 103. The semiconductor wafer is transferred from the inside of the container to the high cleanliness room in the drawing as follows:

(1) The container 102 is mounted on a stage 107 of the loader;

(2) The cover 103 of the container 102 is fixed onto the door 104 of the loader so as to be unified;

(3) Thus fix-unified cover 103 and door 104 is pulled out in a horizontal direction by a driving apparatus disposed in the high cleanliness room, and then lowered vertically to be moved eventually to the position illustrated with a dotted line in the drawing;

(4) The container 102 and the opening portion of the wall 105 are fully opened;

(5) The semiconductor wafer 101 is transferred to the high cleanliness room; and

(6) The semiconductor wafer 101 is worked in the high cleanliness room.

In the above method, however, since the cover 103 and the door 104 of the loader are moved into the high cleanliness room, the dust attached thereto is also moved and scattered into the high cleanliness room. Although it is described in the above disclosure that the dust is fixed within a portion tightly hold between the cover 103 and the door 104 in such manner that the dust is not scattered in the high cleanliness room, it is difficult to completely fix the dust so as not to be scattered. It is therefore difficult to prevent the dust from being scattered.

In addition, since the driving apparatus 106 for moving the cover 13 and the door 104 to the high cleanliness room is required to be disposed in the high cleanliness room, the driving apparatus 106 generates dust in the high cleanliness room. When movable portions in the driving apparatus such as a motor or a cylinder are operated, dust is generated by friction of the portions. Furthermore, lubricants applied to the movable portions are evaporated to be scattered in the high cleanliness room, thus it is impossible to keep high cleanliness therein.

Furthermore, since the cover 103 and the door 104 are moved in a horizontal direction by the driving apparatus 106, and then lowered in a vertical direction, the driving apparatus 106 is required to drive the cover and the door in two directions, thus the apparatus becomes in such complex construction that the accuracy of the operation of the apparatus is apt to be lowered and at the same time the cost of the apparatus increases. Furthermore, the time required for one cycle of the operation increases to lead the product efficiency to be poor.

Furthermore, the dust is inevitably generated when the driving apparatus is kept operable, controlled and repaired. Since the driving apparatus is disposed in the high cleanliness room, the dust is scattered in the high cleanliness room. In addition, when a worker carries out workings in the high cleanliness room, it is required to install an equipment to remove the dust attached to the body of the worker, thus increasing the cost.

The present invention has been made to solve the above problem in the prior art. The object of the invention is therefore to provide a container and a loader for semiconductors by which a semiconductor wafer is received in a container and transported in a low cleanliness room, the semiconductor wafer is worked in a high cleanliness room, and the semiconductor wafer is transported between the container and high cleanliness room without causing dust to float into the high cleanliness room from the low cleanliness room, and generating dust in the high cleanliness room and with easy maintenance, control and repair of the apparatus.

### SUMMARY OF THE INVENTION

In order to attain the above object, there is provided a following invention.

There is provided a first invention, which is a loader disposed in a low cleanliness room along a border between the low cleanliness room and a high cleanliness room, for transporting a dust free article between an inside of a container receiving said dust free article and said high cleanliness room, which comprises:

(a) a stage for mounting said container;

(b) an opening portion through which said dust free article is transported between the inside of said container and said high cleanliness room;

(c) a door for opening and closing said opening portion;

(d) unifying means for unifying a cover of said container and said door when said container approaches said door; and

(e) a driving means for moving unified said cover and said door within said loader to simultaneously open and close said opening portion and said container.

According to the invention, there can be provided a loader in which dust does not float into the high cleanliness room when the dust free article is transported between the inside of the container and the high cleanliness room.

There is provided a second invention, which is a loader, wherein a direction of moving unified said cover and said door within said loader is vertical.

According to the invention, there can be provided a loader in which the bottom area of the loader is made smaller, thus improving efficiency in installing area.

There is provided a third invention, which is a loader, wherein a direction of causing said container mounted on said stage to approach said door is horizontal.

According to the invention, it is possible to stably move the container on the loader.

There is provided a fourth invention, which is a loader, wherein said unifying means for unifying said cover and said door comprises:

(a) a pin for being inserted in a hole formed in a protrusion arranged on outside of said cover;

(b) another pin for being inserted in another hole formed in said door; and

(c) a driving apparatus for simultaneously moving both of said pin and said another pin to unify said cover and said door.

According to the invention, the dust generated by the unifying means can be prevented from floating into the container, since the unifying means is located outside of the container.

There is provided a fifth invention, which is a loader, which further comprises a driving apparatus for causing said container mounted on said stage to approach to said door.

According to the invention, the container can be automatically moved on the loader.

There is provided a sixth invention, which is a container for receiving a dust free article therein and transporting said dust free article, enabling to be mounted on a loader which includes an opening portion disposed in a side of a low cleanliness room in a border portion between a high cleanliness room and said low cleanliness room, and a door for opening and closing said opening portion, which comprises:

(a) an opening port through which said dust free article is transported between an inside of said container and said high cleanliness room;

(b) a cover which enables to cover said opening port, is unified with the door of said loader and is moved within said loader to open and close said opening portion;

(c) fixing means for fixing said cover to said opening port when said dust free article is received in said container and is transported.

According to the invention, there can be provided a container which prevents the dust from floating into the high cleanliness room when the dust free article is transported between the inside of the container and the high cleanliness room.

There is provided a seventh invention, which is a container, wherein a direction of said cover unified with the door of said loader and moved within said loader is vertical.

According to the invention, there can be provided a loader in which the bottom area of the loader is made smaller, thus improving efficiency in installing area.

There is provided a eighth invention, which is a container, wherein an angle formed by a outward normal line on a surface on which said opening port is closely contacted with said cover and a descending direction of said cover unified with the door of said loader and vertically moved within said loader is an acute angle.

According to the invention, it is possible to prevent the dust from being generated by lowering a friction between the contacting surfaces of the opening portion and the cover.

There is provided a ninth invention, which is a container, which further comprises a sealing material for closing a gap between both of said cover and said opening port.

According to the invention, it is possible to prevent the dust from floating into the container.

There is provided a tenth invention, which is a container, which further comprises positioning means to position said container in relation to said loader when said container is mounted on said loader.

According to the invention, the container can be securely mounted on the loader.

There is provided a eleventh invention, which is a container, which further comprises a handle to support said container when said container is transported.

According to the invention, the container can be easily transported by a human being or robot.

There is provided a twelfth invention, which is a container, which further comprises a protrusion formed on outer portion of said cover, which has a hole to which a pin is inserted for unifying said cover and the door of said loader.

According to the invention, the dust generated by the transfer mechanism of the pin or friction between the pin and the protrusion can be prevented from floating into the inside of the container, since the protrusion for unifying is located outside of the container.

There is provided a thirteenth invention, which is an apparatus for transporting a dust free article, including a loader and a container, which comprises: (a) a loader disposed in a side of a low cleanliness room in a border portion between a high cleanliness room and said low cleanliness room, which enables to transport said dust free article between an inside of said container and said high cleanliness room, which comprises:

(a1) a stage for mounting said container enabling to transport said dust free article;

(a2) an opening portion through which said dust free article is transported between said high cleanliness room and said container;

(a3) a door for opening and closing said opening portion;

(a4) unifying means for unifying a cover of said container and said door when said container approaches said door; and

(a5) a driving means for simultaneously opening and closing the opening portion of said loader and said container by moving unified cover and door within said loader; and

(b) a container which comprises:

(b1) an opening port through which said dust free article is transported between an inside of said container and said high cleanliness room;

(b2) a cover which enables to cover said opening port of said container, is unified with the door of said loader and is moved within said loader to open and close said opening port of said container; and

(b3) fixing means for fixing said cover to said opening port of said container when said dust free article is received in said container and is transported.

According to the invention, there can be provided an apparatus for transporting a dust free article which can be prevented the dust from floating into the high cleanliness room when transporting the dust free article between the inside of the container and the high cleanliness room.

There is provided a fourteenth invention, which is an apparatus for transporting a dust free article, wherein a direction of said cover unified with the door of said loader and moved within said loader is vertical.

According to the invention, it is possible to make bottom area of the loader smaller, thus improving efficiency in installing area.

There is provided a fifteenth invention, which is an apparatus for transporting a dust free article, wherein said loader further comprises a driving means for causing said container mounted on said stage to approach said door.

According to the invention, there can be provided an apparatus which enable to automatically move the container on the loader.

There is provided a sixteenth invention, which is a method for transporting a dust free article, using a loader disposed in a side of low cleanliness room in a border portion between a high cleanliness room and said low cleanliness room, and a container enabling to receive said dust free article and be transported, which comprises steps of:

(a) mounting a container receiving said dust free article on a stage disposed on said loader;

(b) causing said container to approach a door of said loader for opening and closing said an opening portion of said loader;

(c) unifying a cover of said container and the door of said loader;

(d) simultaneously moving thus unified cover and door within said loader to simultaneously open the opening portion of said loader and said container; and

(e) transferring said dust free article received in said container from an inside of said container to said high cleanliness room through the opening portion of said loader.

According to the invention, there can be provided a method for transporting a dust free article which can be prevented the dust from floating into the high cleanliness room when transporting the dust free article between the inside of the container and the high cleanliness room.

There is provided a seventeenth invention, which is a method for transporting a dust free article, which further comprises steps of:

(a1) fixing said container mounted on said stage to said stage to unify said container and said stage in step (a); and

(b1) moving said stage by a driving apparatus included in said loader to cause said container to approach the door of said loader in step (b).

According to the invention, there can be provided a method for enabling to automatically move the container on the loader.

There is provided a eighteenth invention, which is a method for transporting a dust free article, wherein a direction of said cover unified with the door of said loader and moved within said loader is vertical.

According to the invention, it is possible to make smaller the bottom area of the installation used in the transporting method, thus improving efficiency in installing area.

### BRIEF DESCRIPTION OF THE DRAWINGS

FIG. 1 is a conceptional view illustrating an embodiment of the prior art in which a sectional view of the container and loader is shown.

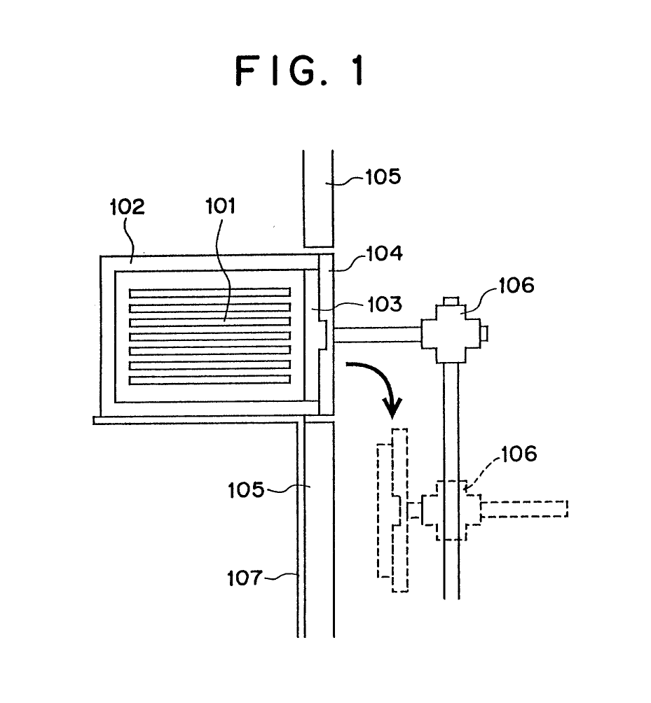

FIG. 2 is a conceptional view illustrating an embodiment of the present invention in which a sectional view of the container and loader of the invention is shown.

FIG. 3 is a conceptional view illustrating an embodiment of the present invention in which a sectional view of the container and loader of the invention is shown.

FIG. 4 is a descriptive view illustrating an example of the container of the invention.

FIG. 5 is a descriptive view illustrating multiple of examples of the container of the invention.

FIG. 6 is a descriptive view illustrating an example of the loader of the invention.

FIG. 7 is a descriptive view illustrating an example when multiple loader are installed in the invention.

FIG. 8 is a descriptive view illustrating an example of unifying means for unifying the door of the loader and the cover of the container of the invention.

### DETAILED DESCRIPTION OF PREFERRED EMBODIMENTS

The best mode of the embodiments of the invention is described hereinbelow. The following embodiments do not limit the scope of the invention. Skilled person in the field can therefore execute other embodiments within a scope of the invention.

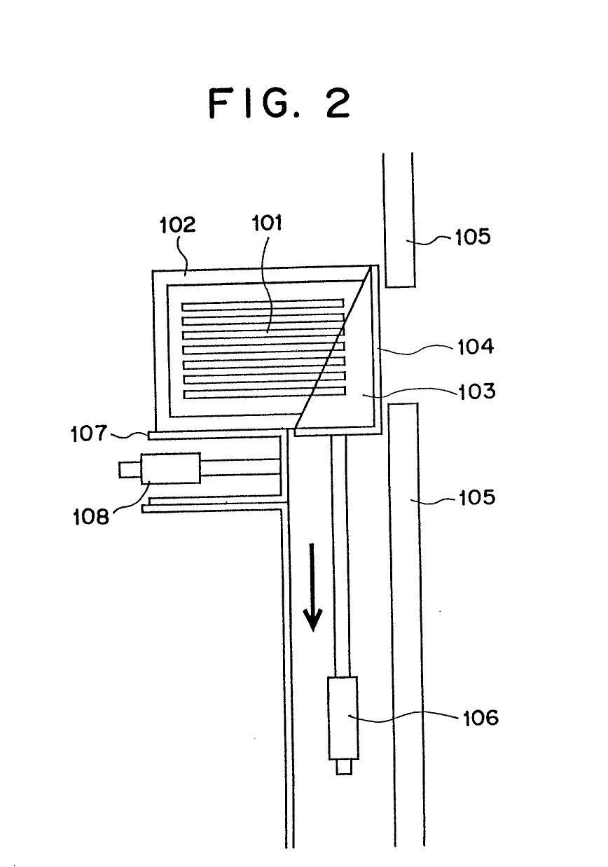

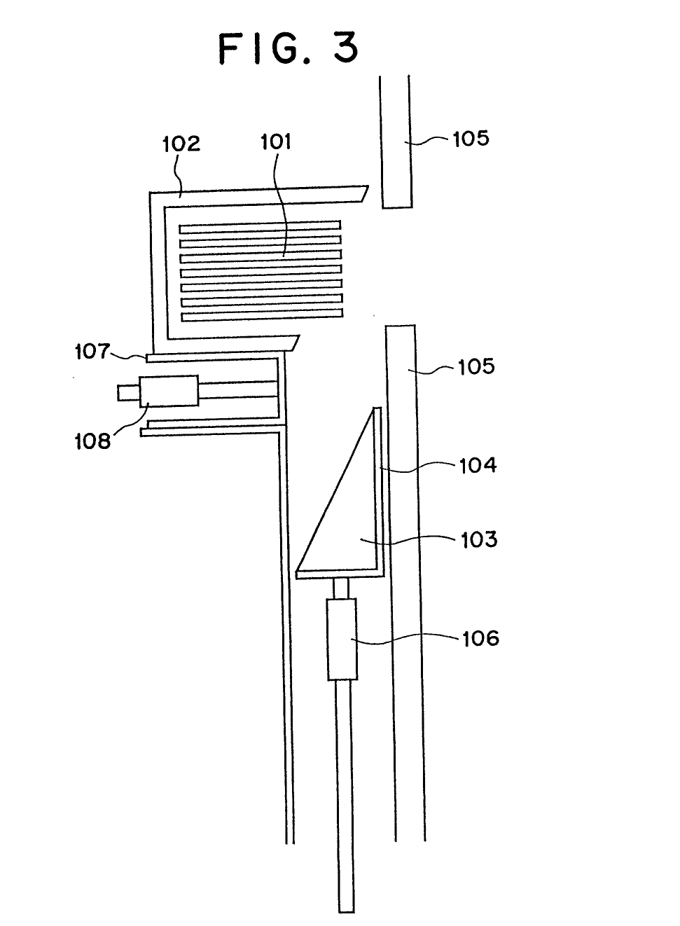

FIGS. 2 and 3 are schematic descriptive view illustrating the container and loader of the invention. In FIG. 2, the high cleanliness room in the right side is separated from the low cleanliness room in the left side by the wall 105. There is arranged an opening portion in the wall 105, which opening portion is usually closed by the door 104 of the loader. Alternatively, as described above, a gap is provided between the door 104 and the opening portion, and the air pressure of the high cleanliness room is controlled so as to be higher than the air pressure of the low cleanliness room, thus causing air to flow from the high cleanliness room to the low cleanliness room to prevent the dust from floating into the high cleanliness room.

The semiconductor wafer is received inside of the container 102, and the container is air-tightly closed. Under this condition, the inside of the container 102 is kept in high cleanliness. Accordingly, when container 102 is transported through the low cleanliness room, the semiconductor wafer 101 in the container is never contaminated.

The process for transporting a semiconductor wafer from the container to the high cleanliness room in the present invention is described hereinbelow.

Firstly, the container 102 is mounted on the stage 107 of the loader. The container 102 may be mounted by the hands of human being, or may be transported by the transporting robot installed in the ceiling or the robot mounted on the AGV running on the floor. For this purpose, a flange may be arranged on the upper portion of the container 102. The above-mentioned transportation may be carried out by the use of the process defined in the standard, for example.

Then, the container 102 is fixed onto the stage 107 in such manner that the container and the stage are unified. The above-mentioned unification is carried out in the predetermined location. For this purpose, the positioning mechanism such as Kinematic Coupling defined in the standard may be disposed. As the method for unifying the container 102 and the stage 107, and positioning, the methods defined in the standard may be applied.

Then, the stage 107 is moved in the direction to the opening portion of the wall 105 to cause the cover 103 to approach the door 104 of the loader. The stage 107 may be moved by the driving mechanism 108. However, there is included the embodiment without the driving mechanism 108 for the stage 107. In this case, when bearings, wheels, rollers and the like, for example, are disposed on the stage to smoothly move the stage in the horizontal direction, the container mounted on the stage may be caused to approach the door 104 by human power. The driving mechanism 108 of the stage 107 is described later.

Then, the cover 103 and the door 104 of the loader are unified. This unification of the cover and the door may be executed by the use of the conventional methods such as a clamp mechanism or frictional means. Embodiments of the unification of the cover and the door are described later.

While the cover 103 is kept fixed to the door 104, the stage 107 is moved backward slightly, thus the cover 103 is removed from the container 102. The above-mentioned moving (driving) mechanism of the stage 107 may be used as it is for the above backward movement. The means to close or open the container by the cover are described later.

Furthermore, the cover 103 together with the door 104 are moved downward by the driving mechanism 106. Thus, the container 102 is opened toward the high cleanliness room. FIG. 3 shows that the container is opened toward the high cleanliness room. In this situation, since the air flows from the high cleanliness room to the low cleanliness room, the dust can be prevented from floating into the high cleanliness room.

Finally, the semiconductor wafer 101 is transported from the inside of the opened container to the high cleanliness room and worked therein. After being worked, the semiconductor wafer 101 may be returned to the same container 102, or received in another container through another opening portion. As the means to transport the semiconductor wafer received in the container between the container and the high cleanliness room, the known means such as a robot arm for transporting, for example, a scalar type robot for clean room may be used. The detailed description thereof are omitted here.

After finishing working, when reverse processes are carried out, the semiconductor wafer 101 can be transported from the high cleanliness room to the container 102 while high cleanliness is kept. Then, when the container 102 is air-tightly closed by the cover 103, the semiconductor wafer can be transported through the low cleanliness room.

In the present invention, when the container is not mounted on the stage 107, the opening portion of the wall 105 is closed by the door 104, thus the dust is prevented from floating into the high cleanliness room from the low cleanliness room. Accordingly, high cleanliness can be maintained in the high cleanliness room.

Furthermore, in the present invention, the cover 103 is unified to the door 104, and thus unified cover and door is moved downward in the low cleanliness room to open both of the opening port of the container and the opening portion of the wall 105. More specifically, since the driving mechanism 106 for driving the cover 103 and the door 104 is located in the low cleanliness room, the dust generated by the driving mechanism 106 does not float into the high cleanliness room. Furthermore, the maintenance, control and repair of the driving mechanism 106 are carried out in the low cleanliness room, thus lowering the required cost thereof.

According to the conventional means, since a single driving mechanism moves the container in both of the horizontal and vertical directions, the driving mechanism becomes complex and the cost thereof increases. In addition, there is a problem in which accuracy of the operation in the driving mechanism is lowered. Contrary to the conventional driving mechanism, in the present invention, the driving mechanism 106 moves the apparatus in the vertical direction, and the stage driving mechanism 108 moves the apparatus in the horizontal direction. More specifically, since each driving mechanism moves the apparatus in only one direction, driving mechanisms comprising simple elements can be applied, thus improving accuracy of the operation and lowering the required cost thereof.

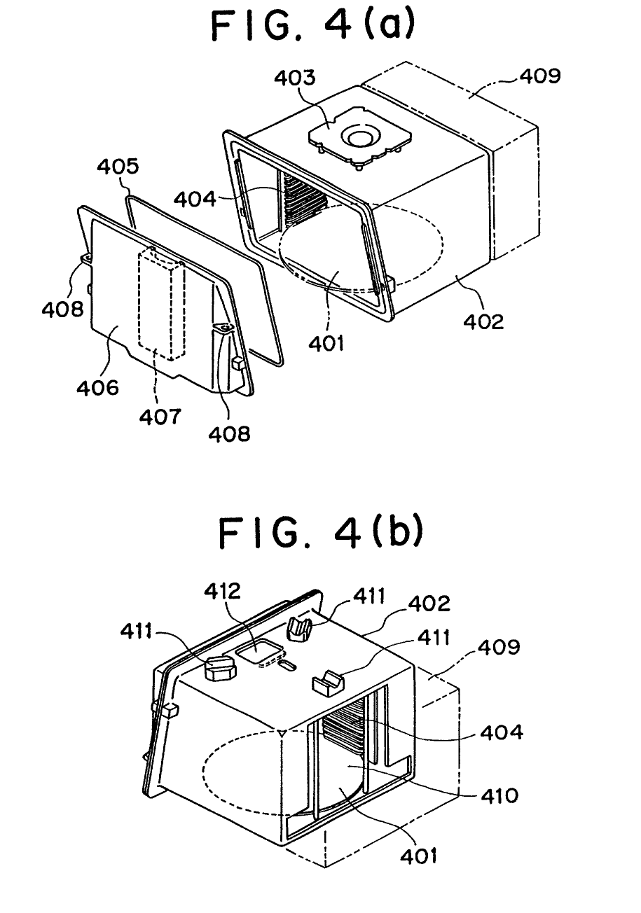

Now, the best embodiment of the container of the invention is described with reference to FIGS. 4(a) and 4(b).

In FIG. 4(a), teeth portion 404 is disposed inside of the container 402 to hold the semiconductor wafer 401. The teeth portion 404 can hold a plurality of semiconductor wafers 401.

A flange 403 is disposed on the upper portion of the container 402. The container 402 is automatically moved by the transporting robot installed in the ceiling with the use of the flange. The shape of the flange 403 is about square, each side of which square has different numbers and shapes of rifts. The contact sensor or the like identifies the direction to which the container faces by means of the rifts. It is preferable to apply the flange, the shape of which is defined in the standard.

The container 402 and the cover 406 are air-tightly sealed by means of an O-ring 405 comprising elastic body. The O-ring 405 may be fixed either to the cover 406 or the container 402.

A wafer pressing device 407 comprising elastic body is disposed on the cover 406 in order to prevent the semiconductor wafer 401 from moving or swinging inside of the container when the container is transported. The hole 408 disposed on the cover 406 is disposed so as to receive the pin which unifies the cover and the door of the loader. The mechanism to unify the cover and the door is described later.

In FIG. 4(b), Kinematic Coupling 411 is disposed on the bottom surface of the container 402. The relative positioning of both of the stage of the loader and the container 402 is carried out by means of the Kinematic Coupling 411. The recess 412 used for clamp mechanism to fix the container 402 to the stage so as to unify the container and the stage. The shape, size and location are preferably in accordance with the standard.

Another opening port, which is different from the opening port of the container located front side thereof, may be disposed in the rear portion of the container 402. In the opening port 410, there can be disposed a air cleaning device 409, for example a fan, which exhausts the air inside of the container 402 to clean the air. However, the above-mentioned another opening port may not be disposed, and the air cleaning device may also not be disposed. In the rear portion of the inside of the container, there may be disposed same wafer pressing device (not shown) as the wafer pressing device 407 disposed on the cover 406 so as to prevent the semiconductor wafer 401 from being damaged.

The cover 406 and the container 402 are air-tightly sealed by means of the O-ring, as described above. In order to more securely seal the cover and the container, there may be disposed a magnet or an adhesive tape on each of the surfaces with which the cover 406 and the container are contacted. Furthermore, there may be disposed a clamp mechanism (not shown) to fix the cover 406 onto the container 402 in such manner that the cover is not removed from the container when the container is transported.

The angle formed by the outward normal line on the surface on which the opening port of the container 402 is contacted with the cover 406, and a descending direction of the cover unified with the door of the loader is up to 90 degrees. With the above angle to be up to 90 degrees, when the cover 406 unified with the door are moved, the container 402 does not disturb the movement of the unified cover and the door.

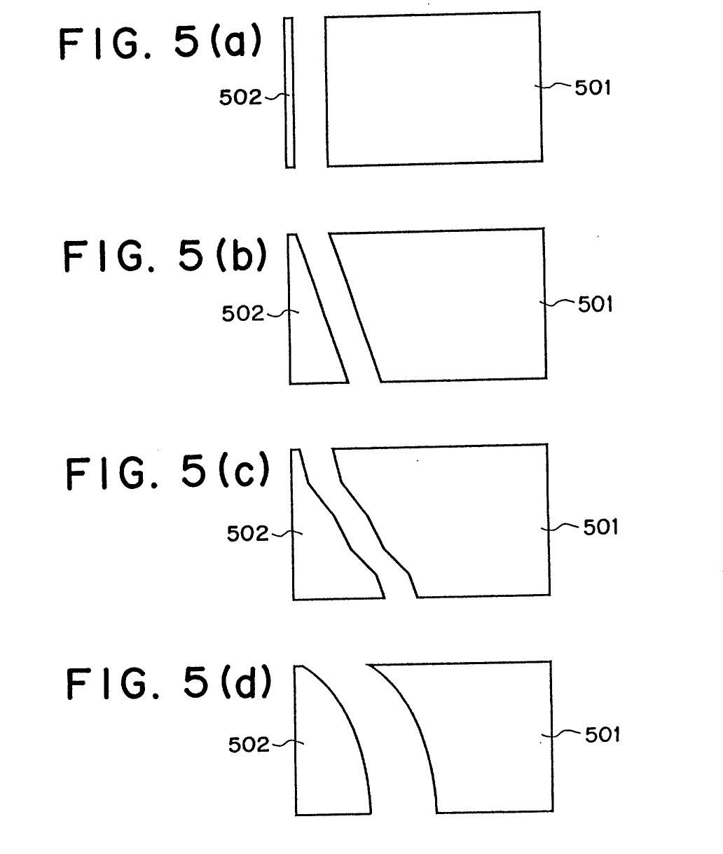

FIGS. 5(a) to 5(d) show various schematic side views of the cover and the container. FIG. 5(a) shows the example in which the angle formed by the outward normal line on the surface on which the opening port of the container 501 is contacted with the cover 502, and a descending direction of the cover unified with the door of the loader is 90 degrees. FIG. 5(b) shows the example in which the angle is about 72 which is not changed. FIG. 5(c) shows the example in which the angle is changed step by step. FIG. 5(d) shows the example in which the angle is changed continuously. Those are the examples in which the angle is positive.

With the above angle to be excessively small, the area of the wall surface and the bottom surface of the container 501 becomes small, thus lowering the (sitting) stability of the container 501. On the other hand, with the angle to be excessively large, the friction between the container 501 or the cover 502 and the elastic O-ring is generated to produce the dust when the cover 502 is moved.

In the present invention, there may be the embodiment in which the container is mounted on the loader, then after the cover and the door are unified, the container is slightly moved backward in the horizontal direction to remove the cover from the main body of the container. In this case, since the gap is produced between the container and the cover, the above-mentioned friction is not generated. Accordingly, it is possible to set the above angle so as to be within the scope from 70 to 90 degrees.

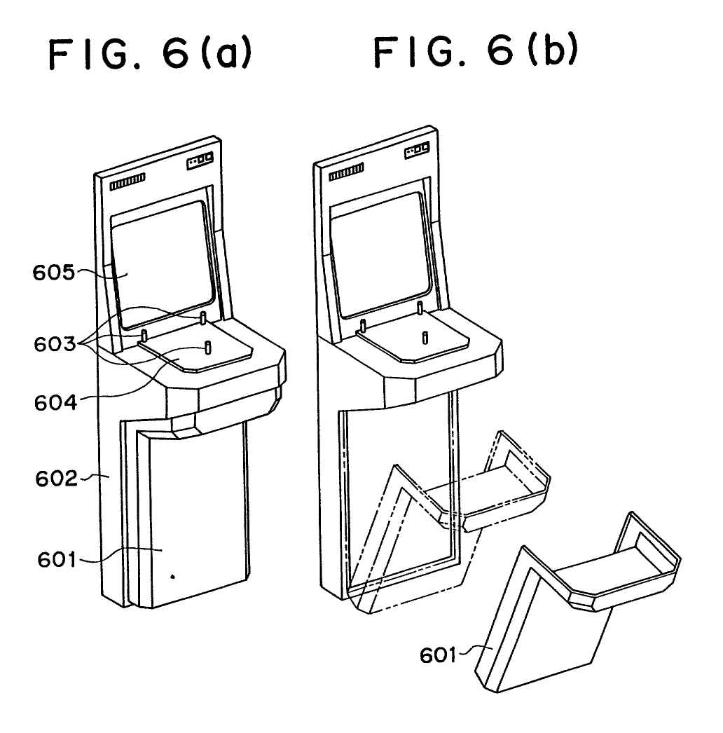

In FIGS. 2 and 3, as described above, the inner mechanism of the loader is briefly described. FIG. 6 shows outward appearance of one of the embodiments of the loader of the invention.

The driving means of the loader is covered by the front cover 601 and the driving means cover 602. The maintenance, inspection and repair of the driving means is easily carried out by pulling the front cover 601 outward (to the frontal direction). The loader as a whole is installed in the low cleanliness room, and the above-mentioned maintenance and the like can be carried out in the low cleanliness room.

On the stage 604 of the loader, there are disposed pins of kinematic coupling which correspond to the V shaped groove of the kinematic coupling of such standard as formed on the bottom portion of the container, which carry out the positioning of the container. The opening portion 605 of the loader is closed by the door when the container is not mounted, and when the container is mounted the door descends downward in such manner that the semiconductor wafer can be transported between the container and the high cleanliness room.

When the air pressure in the high cleanliness room is caused to be kept higher than the air pressure in the low cleanliness room, the dust can be prevented from floating into the high cleanliness room. Furthermore, for example, when the fan for exhausting is disposed in the lower portion of the cover 602, the air flow from the high cleanliness room to the low cleanliness room is assisted or accelerated. Accordingly, even if the dust generated by the operational friction of the mechanical parts inside of the loader, or the organic compound produced by the evaporation of the lubricant is scattered, the dust or organic compound can be effectively prevented from floating into the high cleanliness room. The degree of the cleanliness of the high cleanliness room in the invention can be therefore kept higher than that of the conventional apparatus and method.

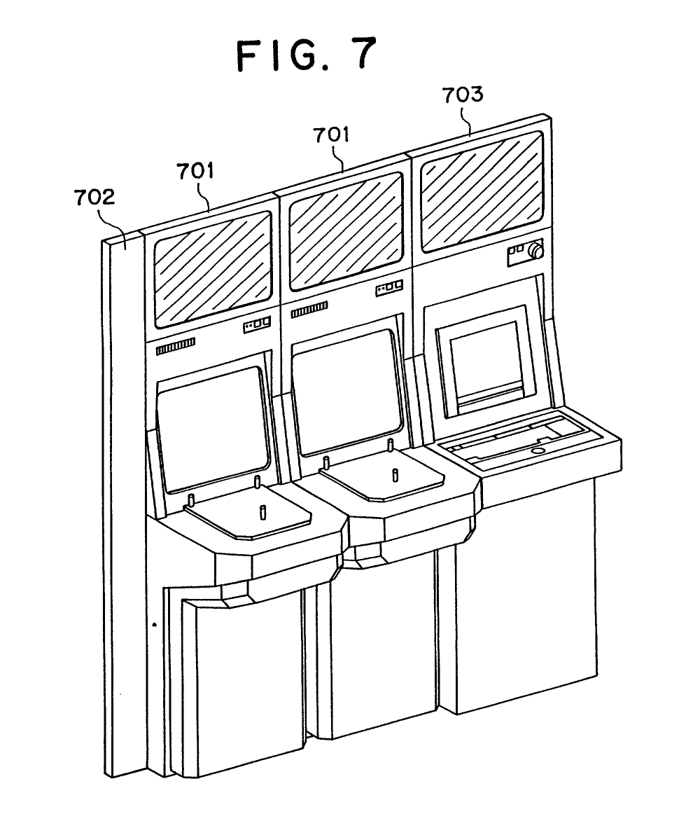

The moving direction of the unified cover and door is not necessarily limited to upward and downward along the vertical direction. The above-mentioned effect can be obtained as far as the unified cover and door moves within the loader installed in the low cleanliness room. However, when the moving direction is selected so as to be the vertical or about vertical direction, it is possible to arrange the loader of the invention side by side in the lateral direction, as shown in FIG. 7.

FIG. 7 shows the example in which two loaders 701 and the control board 703 are arranged on the wall 702. According to this arrangement, for example, one loader is restricted to solely carry in the semiconductor wafer, and the other loader is restricted to solely carry out the semiconductor wafer, thus enabling to transport and work the semiconductor wafer in sequential operation. Furthermore, since the bottom area of the loader itself is relatively small, the area is efficiently used when the loaders are installed in the factory.

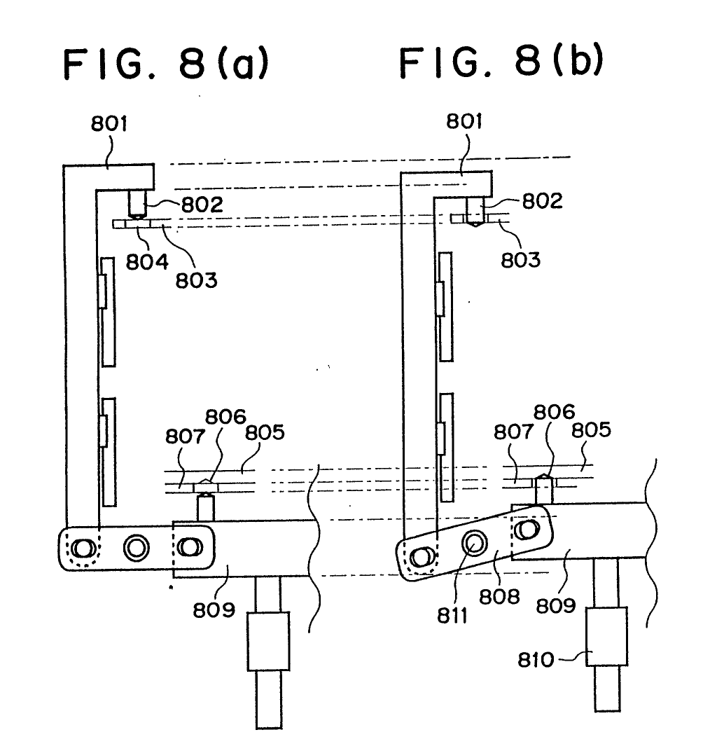

FIG. 8 shows one example of the means to unify the cover and the door. There is disposed the protrusion 803 having the hole 804 on the outer portion of the cover of the container, and there is disposed a hole on the bottom portion 807 of the door of the loader. In addition, there is disposed the recess 806 on the bottom portion 805 of the cover which corresponds to the hole of the bottom portion 807 of the door of the loader. The unifying mechanism for unifying the cover and the door is disposed in the loader. The driving mechanism 810 is caused to take such rectilinear motion that the rotary lever 808 is caused to rotate around the axis 811. As a result, the bar 801 descends, and the pin located at the tip portion thereof thrusts the hole 804 of the protrusion 803 on the cover of the container. At the same time, the supporter 809 ascends, and the pin located at the tip portion thereof thrusts the hole of the bottom portion 807 of the door and is received in the recess 806 of the bottom portion 805 of the cover. As described above, according to the present invention, by preparing such a simple rectilinear motion mechanism 810, rotary lever 811, and the bar 801 and supporter 809, it is possible to provide the unifying mechanism of the door and the cover with a low cost.

In the conventional art, since the lock mechanism to unify the cover and the door is installed inside of the container, when the cover and the door are opened, the dust generated by the lock mechanism may floats into the inside of the container by the air flow of the high cleanliness room, thus contaminating the inside of the container. On the contrary, in the present invention, since the lock mechanism can be installed outside of the container, the inside of the container is never contaminated.

As described above, according to the invention, the semiconductor wafer can be effectively prevented from being contaminated by the dust even when the container is transported through the low cleanliness room, since the semiconductor wafer is received and transported by the sealed container. When the semiconductor is to be worked, the cover of the container and the door of the loader are unified, and thus unified cover and door descends in the low cleanliness room, thus the container and the high cleanliness room are opened and the semiconductor wafer is transported between the container and the high cleanliness room. Since all the mechanical elements to generate the dust are disposed in the low cleanliness room side, it is possible to keep high degree of high cleanliness in the high cleanliness room.

The present invention can be applied not only to the working of the semiconductor, but also to the container and the loader for the articles other than the semiconductor which require high cleanliness in the working thereof.

What is claimed is:

1. A loader disposed in a low cleanliness room along a border between the low cleanliness room and a high cleanliness room, for transporting a dust free article between an inside of a container receiving said dust free article and said high cleanliness room, which comprises:
(a) a stage for mounting said container;
(b) an opening portion through which said dust free article is transported between the inside of said container and said high cleanliness room;
(c) a door for opening and closing said opening portion;
(d) unifying means for unifying a cover of said container and said door when said container approaches said door; and
(e) a driving portion for moving unified said cover and said door within said loader to simultaneously open and close said opening portion and said container.

2. A loader as claimed in claim 1, wherein a direction of moving unified said cover and said door within said loader is vertical.

3. A loader as claimed in claim 1, wherein a direction of causing said container mounted on said stage to approach said door is horizontal.

4. A loader as claimed in claim 1, wherein said unifying means for unifying said cover and said door comprises:
(a) a pin for being inserted in a hole formed in a protrusion arranged on outside of said cover;
(b) another pin for being inserted in another hole formed in said door; and
(c) a driving apparatus for simultaneously moving both of said pin and said another pin to unify said cover and said door.

5. A loader as claimed in claim 1, which further comprises a driving apparatus for causing said container mounted on said stage to approach to said door.

6. A container for receiving a dust free article therein and transporting said dust free article, enabling to be mounted on a loader which includes an opening portion disposed in a side of a low cleanliness room in a border portion between a high cleanliness room and said low cleanliness room, and a door for opening and closing said opening portion, which comprises:
(a) an opening port through which said dust free article is transported between an inside of said container and said high cleanliness room;
(b) a cover which enables to cover said opening port, is unified with the door of said loader and is moved within said loader to open and close said opening portion;
(c) fixing means for fixing said cover to said opening port when said dust free article is received in said container and is transported.

7. A container as claimed in claim 6, wherein a direction of said cover unified with the door of said loader and moved within said loader is vertical.

8. A container as claimed in claim 7, wherein an angle formed by a outward normal line on a surface on which said opening port is closely contacted with said cover and a descending direction of said cover unified with the door of said loader and vertically moved within said loader is an acute angle.

9. A container as claimed in claim 6, which further comprises a sealing material for closing a gap between both of said cover and said opening port.

10. A container as claimed in claim 6, which further comprises positioning means to position said container in relation to said loader when said container is mounted on said loader.

11. A container as claimed in claim 6, which further comprises a handle to support said container when said container is transported.

12. A container as claimed in claim 6, which further comprises a protrusion formed on outer portion of said cover, which has a hole to which a pin is inserted for unifying said cover and the door of said loader.

13. An apparatus for transporting a dust free article, including a loader and a container, which comprises:
(a) a loader disposed in a side of a low cleanliness room in a border portion between a high cleanliness room and said low cleanliness room, which enables to transport said dust free article between an inside of said container and said high cleanliness room, which comprises:
(a1) a stage for mounting said container enabling to transport said dust free article;
(a2) an opening portion through which said dust free article is transported between said high cleanliness room and said container;
(a3) a door for opening and closing said opening portion;
(a4) unifying means for unifying a cover of said container and said door when said container approaches said door; and
(a5) a driving portion for simultaneously opening and closing the opening portion of said loader and said container by moving unified cover and door within said loader; and
(b) a container which comprises:
(b1) an opening port through which said dust free article is transported between an inside of said container and said high cleanliness room;
(b2) a cover which enables to cover said opening port of said container, is unified with the door of said loader and is moved within said loader to open and close said opening port of said container; and
(b3) fixing means for fixing said cover to said opening port of said container when said dust free article is received in said container and said container is transported.

14. An apparatus for transporting a dust free article as claimed in claim 13, wherein a direction of said cover unified with the door of said loader and moved within said loader is vertical.

15. An apparatus for transporting a dust free article as claimed in claim 13, wherein said loader further comprises a driving portion for causing said container mounted on said stage to approach said door.

16. A method for transporting a dust free article, using a loader disposed in a side of low cleanliness room in a border portion between a high cleanliness room and said low cleanliness room, and a container enabling to receive said dust free article and be transported, which comprises steps of:
(a) mounting a container receiving said dust free article on a stage disposed on said loader;
(b) causing said container to approach a door of said loader for opening and closing said opening portion of said loader;
(c) unifying a cover of said container and the door of said loader;
(d) simultaneously moving thus unified cover and door within said loader to simultaneously open the opening portion of said loader and said container; and
(e) transferring said dust free article received in said container from an inside of said container to said high cleanliness room through the opening portion of said loader.

17. A method for transporting a dust free article as claimed in claim 16, which further comprises steps of:
(a1) fixing said container mounted on said stage to said stage to unify said container and said stage in step (a); and
(b1) moving said stage by a driving apparatus included in said loader to cause said container to approach the door of said loader in step (b).

18. A method for transporting a dust free article as claimed in claim 16, wherein a direction of said cover unified with the door of said loader and moved within said loader is vertical.
